(19) United States
(12) Patent Application Publication
(10) Pub. No.: US 2014/0358722 A1
(43) Pub. Date: Dec. 4, 2014

(54) SMART SHOPPING REMINDERS WHILE DRIVING

(71) Applicant: SONY CORPORATION, Tokyo (JP)

(72) Inventors: David George Thiele, San Diego, CA (US); Marvin DeMerchant, San Diego, CA (US); David Andrew Young, San Diego, CA (US); Steven Friedlander, San Diego, CA (US)

(21) Appl. No.: 13/909,267

(22) Filed: Jun. 4, 2013

(51) Int. Cl. G06Q 30/06

(52) U.S. Cl. CPC G06Q 30/0633
USPC 705/26.8

(57) ABSTRACT

A user of a wireless communication device (WCD) is reminded to stop at a store along a route of the user's vehicle based on a list of items needed, geographic location, and previous established behavior patterns, e.g., whether the user has stopped at a particular store close to the current time of day, along the current route of the vehicle, one or more times before. Shopping locations are verified at the location with a simple confirmation dialog on the WCD and suggested names are provided from a list of points of interests. Items to be purchased can then be added to a location-based shopping list by using a digital camera on the WCD to image the item and/or the barcode of the item and find the item in a database of images and barcodes.

### I. FIELD OF THE INVENTION

The present application relates generally to smart shopping reminders while driving.

### II. BACKGROUND OF THE INVENTION

Perhaps the most fundamental concern in the information age is getting the right information at the right time to a person when that person needs it but may not immediately be aware of the need, in a manner that avoids inundating the person with unneeded or unwanted information. Present principles focus on people who may be driving on an errand and be close to a retail outlet at which an item needed by the person or the person's family can be obtained, but the person does not know or remember if the item is needed and thus cannot efficiently leverage the errand into additional usefulness.

### SUMMARY OF THE INVENTION

An apparatus includes a computer readable storage medium that is not a carrier wave and that is accessible to a client processor of a client device and bearing instructions which when executed by the client processor configure the processor to execute logic to execute a method that includes determining whether a user activity trigger satisfies a test. The activity trigger is not a user input to the WCD. Responsive to a determination that the user activity trigger satisfies the test, the processor presents a shopping list on the WCD, whereas responsive to a determination that the user activity trigger does not satisfy the test, the shopping list is not presented on the WCD.

In example embodiments the user activity trigger is motion at a speed above a threshold. The user activity trigger can be an indication that a user of the WCD is in a vehicle. For example, the user activity trigger can be an establishment of communication between the WCD and a vehicle. Or, the user activity trigger can include a reception by the WCD of a message from another user.

In any case, in some implementations the method implemented by the processor when the processor is configured by the instructions further includes, responsive to a determination that a location of the WCD is within a threshold distance of a location of a store, presenting a list on the WCD and/or a vehicle in which the WCD is located of items that are candidates for purchase. If desired, the list may be pruned by time of day. In a specific example the method implemented by the processor when the processor is configured by the instructions further may include receiving a message at the WCD indicating a name of an item that a person other than the user wishes the user to buy. Responsive to the message, the processor determines a store carrying the item and presents on the WCD and/or on a vehicle in which the WCD is disposed at least a name of the store and an identification of the item.

In another aspect, an apparatus includes a computer readable storage medium that is not a carrier wave and that is accessible to a client processor of a client device and bearing instructions which when executed by the client processor configure the processor to execute logic to execute a method that includes automatically and without user input, determining that a trigger event has occurred. The trigger event is not user input to the WCD. Responsive to determining that the trigger event has occurred, the processor presents, using the WCD, a user interface (UI). The UI can include a message that a particular store is nearby, along with a list of items previously purchased by a user of the WCD at the store.

In another aspect, a method includes using a wireless communication device (WCD) to receive a signal that is not input by a user of the WCD. Responsive to the signal, the WCD is used to present to the user at least one item and at least one store at which the item can be obtained.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system according to present principles;

FIG. 2 is a flow chart of example overall logic;

FIG. 3 is a flow chart of example initialization logic;

FIG. 4 is a flow chart of example specific logic;

FIG. 5 is a flow chart of another example of specific logic; and

FIGS. 6-8 illustrate example user interfaces (UIs) according to the flow charts of FIGS. 3-5.

### DETAILED DESCRIPTION OF THE PREFERRED EMBODIMENT

Disclosed are methods, apparatus, and systems for computer based user information. A system herein may include server and client components, connected over a network such that data may be exchanged between the client and server components. The client components may include one or more computing devices. These may include personal computers, laptops, tablet computers, and other mobile devices including smart phones. These client devices may operate with a variety of operating environments. For example, some of the client computers may be running Microsoft Windows® operating system. Other client devices may be running one or more derivatives of the Unix operating system, or operating systems produced by Apple® Computer, such as the IOS® operating system, or the Android® operating system, produced by Google®. While examples of client device configurations are provided, these are only examples and are not meant to be limiting. These operating environments may also include one or more browsing programs, such as Microsoft Internet Explorer®, Firefox, Google Chrome®, or one of the other many browser programs known in the art. The browsing programs on the client devices may be used to access web applications hosted by the server components discussed below.

Server components may include one or more computer servers executing instructions that configure the servers to receive and transmit data over the network. For example, in some implementations, the client and server components may be connected over the Internet. In other implementations, the client and server components may be connected over a local intranet, such as an intranet within a school or a school district. In other implementations a virtual private network may be implemented between the client components and the server components. This virtual private network may then also be implemented over the internet or an intranet.

The data produced by the servers may be received by the client devices discussed above. The client devices may also generate network data that is received by the servers. The server components may also include load balancers, firewalls, caches, and proxies, and other network infrastructure known in the art for implementing a reliable and secure web site infrastructure. One or more server components may form an apparatus that implement methods of providing a secure community to one or more members. The methods may be implemented by software instructions executing on processors included in the server components. These methods may utilize one or more of the user interface examples provided below in the appendix.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as the AMD® Athlon® II or Phenom® II processor, Intel® i3®/i5®/i7® processors, Intel Xeon® processor, or any implementation of an ARM® processor. In addition, the processor may be any conventional special purpose processor, including OMAP processors, Qualcomm® processors such as Snapdragon®, or a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. The description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be written in any conventional programming language such as C#, C, C++, BASIC, Pascal, or Java, and run under a conventional operating system. C#, C, C++, BASIC, Pascal, Java, and FORTRAN are industry standard programming languages for which many commercial compilers can be used to create executable code. The system may also be written using interpreted languages such as Pert Python or Ruby. These are examples only and not intended to be limiting.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a, computer-readable medium. Computer-readable media include both computer storage media and communication media including any medium that facilitates transfer of a computer program from one place to another. However, a computer readable storage medium is not a carrier wave, and may be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.) It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting.

Referring initially to FIG. 1, a system 10 includes at least one and in the example shown “N” user or client devices 12 communicating via a computer cloud 14 such as the Internet with one or more server computers. In the example shown, a weather server 16, a traffic server 18, and in general one or more servers 20 communicate with the client device 12 through the cloud.

Among the non-limiting and example components a client device 12 may incorporate, a processor 22 accesses a computer readable storage medium 24 that contains instructions which when executed by the processor configure the processor to undertake principles disclosed below. The client device 12 may communicate with other client devices using a wireless short range communication interface 26 such as but not limited to a Bluetooth transceiver controlled by the processor 22. Also, the client device 12 may communicate with the cloud 14 using a wireless network interface 28 such as but not limited to one or more of a WiFi transceiver, wireless modem, wireless telephony transceiver, etc. controlled by the processor 22. Wired interfaces 26, 28 are also contemplated.

The client device typically includes a visual display 30 such as a liquid crystal display (LCD) or light emitting diode (LED) display or other type of display controlled by the processor 22 to present demanded images. The display 30 may be a touch screen display. In addition, one or more input devices 32 may be provided for inputting user commands to the processor 22. Example input devices include keypads and keyboards, point-and-click devices, a microphone inputting voice commands to a voice recognition engine executed by the processor 22, etc. A position sensor 34 may input signals to the processor 22 representing a location of the client device 12. While FIG. 1 assumes that the position receiver 34 is a global positioning satellite (GPS) receiver, other position sensors may be used in addition or in lieu of a GPS receiver. For example, a motion sensor 35 such as an accelerometer, gyroscope, magnetic sensor, and the like may be used to input position information to the processor 22. Location information may also be derived from WiFi information, e.g., the location of the client device may be inferred to be the location of a WiFi hotspot in which the device is communicating. Also, a camera 37 may provide image signals to the processor 22.

FIG. 1 also shows that a person carrying the client device 12 may decide to enter a vehicle 36. The vehicle 36 may include a communication interface 38 controlled by a vehicle processor 40 accessing a computer readable storage medium 42. The interface 38 may be configured to communicate with one of the interfaces of the client device 12 and may be a Bluetooth transceiver. The vehicle 36 may include an onboard GPS receiver 44 or other position receiver sending signals to the processor 40 representing the location of the vehicle 36. The vehicle processor 40 may control a visual display 46 in the vehicle to, e.g., present an electronic map thereon and other user interfaces. Other client devices may be transported by their users into other vehicles and establish communication with the processors of the other vehicles.

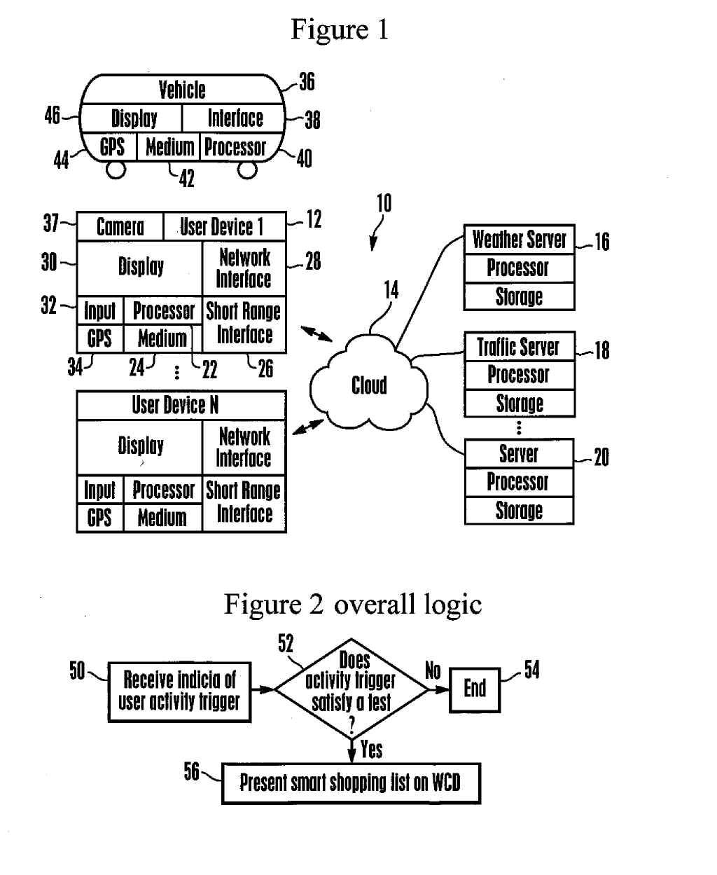

FIG. 2 shows overall logic according to present principles. Assume the client device 12 is a user's wireless communication device (WCD). Commencing at block 50, a signal is received by the WCD that is indicates a user activity trigger. The user activity trigger may be, e.g., motion at a speed above a threshold, indicating the user is traveling in a vehicle. The speed can be determined by the WCD 12 by comparing signals from the GPS receiver 34 over time and determining velocity by dividing a distance between two successive GPS locations by the time period that elapsed between receiving the signals. Or, the activity trigger may be the communicative pairing of the WCD 12 with the vehicle 36 using Bluetooth pairing. Yet again, the activity trigger may be the communicative pairing of the WCD 12 with the vehicle 36 over WiFi. Still further, the activity trigger may be the reception by the WCD 12 of a message from another user. Or, the activity trigger can be proximity (within a threshold distance, as indicated by, e.g., GPS data) to a store in which the user has shopped previously. In any case, the activity trigger need not be a user input into the WCD 12, such as an input command to display a shopping list.

Proceeding to decision diamond 52, the logic determines whether the user activity trigger satisfies a test, and if not the logic may end at block 54. However, if the activity trigger satisfies the test, a shopping list of one or more items to be purchased can be presented on the WCD. Various example tests that can be compared against the signal indicating the user activity trigger are described further below.

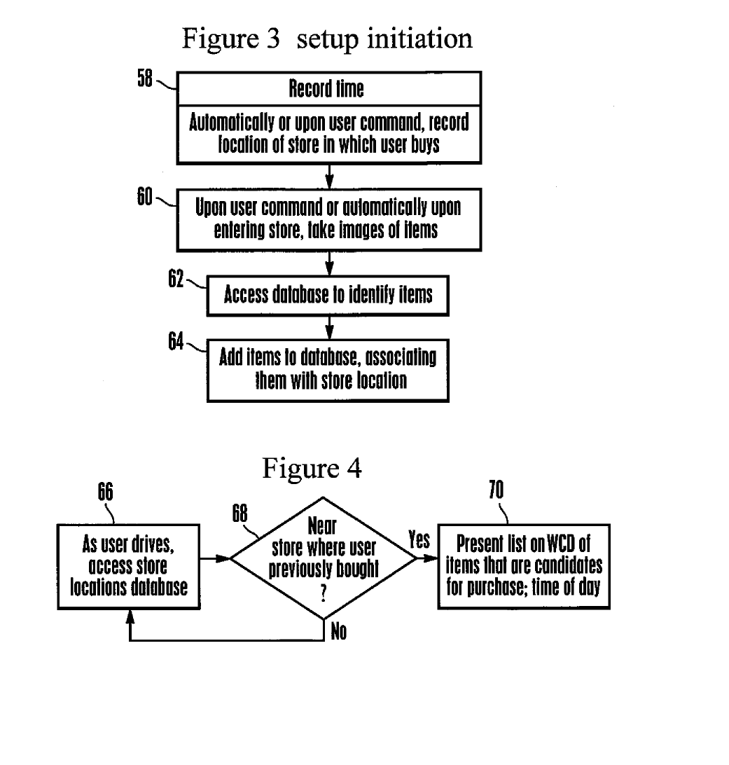

FIG. 3 shows setup logic that may be used in some examples to initiate present principles. Commencing at block 58, automatically or upon user command, a location and/or other ID of a store in which the user purchases items can be recorded. The time of day the user purchased the items also can be recorded. The items may be identified by scanning their bar codes and/or images into the WCD 12, with the time of day as maintained by the clock of the processor 22 and location of the store as determined according to principles below being associated with the purchases.

Subsequently and now moving to block 60, upon user command to begin imaging items in a store or automatically without user command, the WCD 12 may image items that appear in the field of view of the camera 37 in FIG. 1. When automatic imaging is invoked, for example by default or by used selection from a setup user interface (UI) presented on the display 30 of the WCD 12 as further described below, imaging may commence based on the WCD determining its present location is coterminous with a location of a store as indicated by, e.g., a location in an electronically stored map accessible to the processor 22 on the medium 24 and/or over the cloud 14 on an Internet server 20. Thus, in making the determination the WCD 12 may employ signals from the GPS receiver 34 to determine its location and compare the location with store locations on the map, commencing imaging when a substantial match is found. Or, the determination that the WCD 12 is in a store may be made based on the WCD 12 establishing Bluetooth communication with a store device whose ID indicates it is a store device, or by the WCD 12 establishing WiFi communication with an in-store hotspot router or other wireless communication device.

Moving to block 62, the WCD 12 can access a database to compare images of items and/or their imaged bar codes against images in the database to identify the names of the imaged items. The database may be stored on the local storage medium 24, or on a cloud server 20, or distributed among multiple storage media. At block 64, identified items can be added to the database or if already there associated with the ID of the store in which the items were imaged.

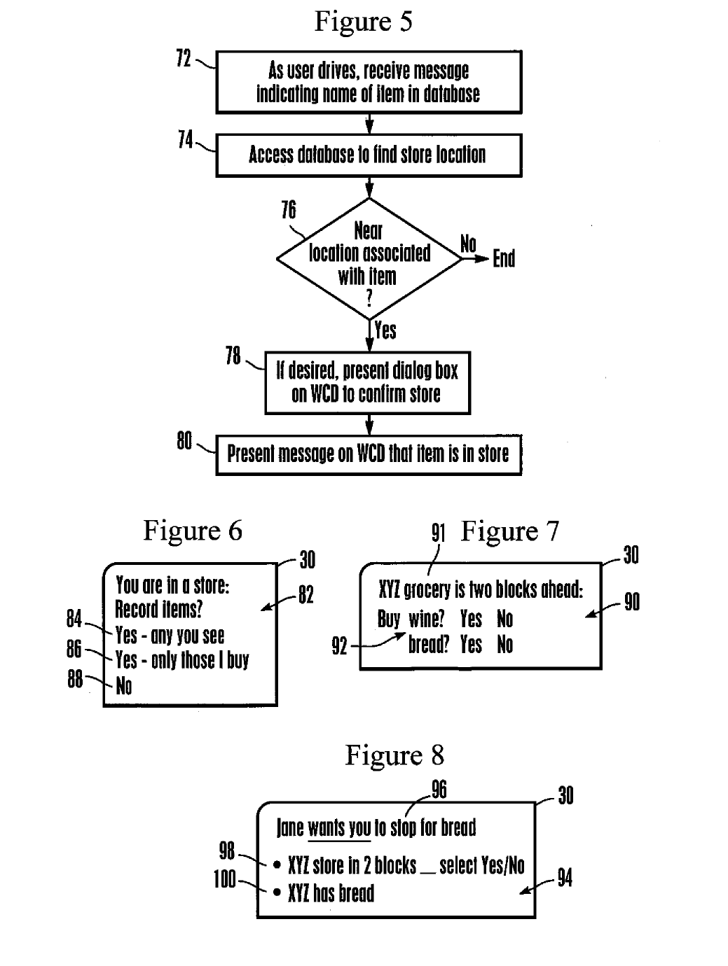

After setting up the data according to FIG. 3, specific logic that may be implemented is shown in FIGS. 4 and 5. Commencing at block 66 in FIG. 4, as the user is driving the vehicle 36, the WCD 12 (which in some embodiments may be incorporated into the vehicle 36 itself) accesses a store location database. The database may contain only stores that were entered into it in FIG. 3. In any case, the WCD 12 may infer the user is in the vehicle by any of the methods described above. Decision diamond 68 indicates that when the location of the user is near, e.g., within a threshold distance of, a store location as indicated in the database, a list is presented on the display of the WCD 12 and/or vehicle of items that are candidates for purchase. The list may be pruned if desired by time of day, i.e., only items associated with the store under test that were purchased previously by the user at a time of day that is within a threshold period around the current time of day, for example, within an hour of the current time albeit on other days, may be presented on the list. The logic in FIG. 4 can be automatic, i.e., once the user activates the application the WCD 12 monitors location and automatically presents shopping lists as described without further user interaction. Note further that presentation and/or display of all information herein may be visual, audible, or both visual and audible.

FIG. 5, in contrast, shows an example in which greater user control of the shopping list presentation is facilitated. Commencing at block 72, as the user drives as determined using one of the example methods above, a message is received by the WCD 12, e.g., by voice mail, text, phone call, or other means, indicating a name of an item that a person other than the user wishes the user to buy. In response, at block 74 the database is accessed to find a location of a store carrying the item. Database access may be effected by using the name of the item as entering argument into the database.

When stores are identified in the database as carrying the requested item, the location of the user is compared to the location of the stores, typically to the location of store nearest the current location of the user. When it is determined at decision diamond 76 that the user is within a threshold distance of a store, the logic may move to block 78 to open a dialog box on the audio or visual display of the WCD 12 telling the user of the store name and location and asking the user to confirm that the user will shop in that store. At block 80 a message is presented on the WCD 12 that the requested item from block 72 is in the store confirmed at block 78, along with, if desired, directions to the store. Note that once a store has been located at block 74, the logic may immediately flow to block 80 to inform the user that an item has been requested, who requested the item, what the item is, and where the item can be purchased typically by returning a store that is closest to the location of the user or by returning a store that is closest in the direction of travel of the user, if not closest absolutely, recognizing that it can be more convenient to stop off at a store a mile along a current route rather than turn around and go back to a store a quarter mile behind the user relative to the current route.

The UI may also alert the user that a deadline to purchase an item on the shopping list is impending. The deadline may be entered by the other user who sent the message at block 72, or it may be obtained from an automatically accessed website affiliated with the store and indicating the expiration of, for example, a discounted price of an item on the shopping list.

FIGS. 6-8 illustrate various example UIs according to principles set forth above. As shown in FIG. 6, a UI 82 may be presented on the visual display 30 of the WCD 12. As mentioned above, however, the UIs herein may also or alternatively be presented audibly and/or on the audio or visual displays 46 of the vehicle 36.

As shown, the UI 82, which can be used in conjunction with the logic of FIG. 3, prompts a user that the user is in a store, asking whether the user wants to record items in the store. The user can select a selector 84 to cause the WCD 12 to image all items that come into the field of the camera 37, or the user can select a selector 86 to cause the WCD 12 to image only items that the user buys. Subsequently to selecting this selector 86 the user, e.g., at checkout, scans bar codes of the items in front of the camera 37 and the WCD 12 records those bar codes. Or, the user can select 88 not to image any items in the store.

FIG. 7 shows a UI 90 that can be used in connection with the logic of FIG. 4. As shown, a message 91 can be presented that a particular store is nearby, along with a list 92 of items previously purchased by the user at that store. The user can select to purchase each item if desired or can simply take the list into the store to buy the items.

FIG. 8 shows a UI 94 that can be used in connection with the logic of FIG. 5. As shown, a message 96 can be presented that a particular third party wants the user to buy a particular item, in the example shown bread. A selector 98 essentially indicates a dialog asking the user to confirm that a nearby store located as described above is a candidate for shopping, and the user can select “yes” or “no”. A “no” selection can bring up another store. A message 100 indicates that the store indicated at 98 has the requested item.

While the particular SMART SHOPPING REMINDERS WHILE DRIVING is herein shown and described in detail, it is to be understood that the subject matter which is encompassed by the present invention is limited only by the claims.

What is claimed is:

1. Apparatus comprising:
at least one computer readable storage medium that is not a carrier wave and that is accessible to a processor of a wireless communication device (WCD) and bearing instructions which when executed by the processor configure the processor to execute logic to execute a method comprising:
determining whether a user activity trigger satisfies a test, the activity trigger not being a user input to the WCD;
responsive to a determination that the user activity trigger satisfies the test, presenting a shopping list on the WCD; and
responsive to a determination that the user activity trigger does not satisfy the test, not presenting the shopping list on the WCD.

2. The apparatus of claim 1, wherein the user activity trigger is motion at a speed above a threshold.

3. The apparatus of claim 1, wherein the user activity trigger is an indication that a user of the WCD is in a vehicle.

4. The apparatus of claim 1, wherein the user activity trigger is an establishment of communication between the WCD and a vehicle.

5. The apparatus of claim 1, wherein the user activity trigger includes a reception by the WCD of a message from another user.

6. The apparatus of claim 1, wherein the method implemented by the processor when the processor is configured by the instructions further includes:
responsive to a determination that a location of the WCD is within a threshold distance of a location of a store, presenting a list on the WCD and/or a vehicle in which the WCD is located of items that are candidates for purchase.

7. The apparatus of claim 6, wherein the list is pruned by time of day.

8. The apparatus of claim 1, wherein the method implemented by the processor when the processor is configured by the instructions further includes:
receiving a message at the WCD indicating a name of an item that a person other than the user wishes the user to buy;
responsive to the message, determining a store carrying the item; and
presenting on the WCD and/or on a vehicle in which the WCD is disposed at least a name of the store and an identification of the item.

9. Apparatus comprising:
at least one computer readable storage medium that is not a carrier wave and that is accessible to a processor of a wireless communication device (WCD) and bearing instructions which when executed by the processor configure the processor to execute logic to execute a method comprising:
automatically and without user input, determining that a trigger event has occurred, the trigger event not being user input to the WCD; and
responsive to determining that the trigger event has occurred, presenting using the WCD a user interface (UI) including:
a message that a particular store is nearby, along with a list of items previously purchased by a user of the WCD at the store.

10. The apparatus of claim 9, wherein the wherein the trigger event is motion at a speed above a threshold.

11. The apparatus of claim 9, wherein the trigger event is an indication that a user of the WCD is in a vehicle.

12. The apparatus of claim 9, wherein the trigger event is an establishment of communication between the WCD and a vehicle.

13. The apparatus of claim 9, wherein the trigger event includes a reception by the WCD of a message from another user.

14. A method comprising:
using a wireless communication device (WCD), receiving a signal not input by a user of the WCD; and
responsive to the signal, using the WCD to present to the user at least one item and at least one store at which the item can be obtained.

15. The method of claim 14, wherein the signal establishes a user activity trigger, and the method further comprises:
determining whether the user activity trigger satisfies a test;
responsive to a determination that the user activity trigger satisfies the test, presenting the at least one item and at least one store at which the item can be obtained as a shopping list on the WCD; and
responsive to a determination that the user activity trigger does not satisfy the test, not presenting the shopping list on the WCD.

16. The method of claim 15, wherein the user activity trigger is motion at a speed above a threshold.

17. The method of claim 15, wherein the user activity trigger is an indication that a user of the WCD is in a vehicle.

18. The method of claim 15, wherein the method further includes:
responsive to a determination that a location of the WCD is within a threshold distance of a location of a store, presenting a list on the WCD and/or a vehicle in which the WCD is located of items that are candidates for purchase.

19. The method of claim 18, wherein the list is pruned by time of day.

20. The method of claim 15, wherein the method further includes:
receiving a message at the WCD indicating a name of an item that a person other than the user wishes the user to buy;
responsive to the message, determining a store carrying the item; and
presenting on the WCD and/or on a vehicle in which the WCD is disposed at least a name of the store and an identification of the item.
